(19) United States
(12) Patent Application Publication
(10) Pub. No.: US 2008/0253543 A1
(43) Pub. Date: Oct. 16, 2008

(54) Multi-User System for Call Back Call-Through and Follow Me Features Using Analogs Lines and Data Link

(75) Inventor: Avihai Aharon, Haifa (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: BOOMERING COMMUNICATION (2005) LTD., Netanya (IL)

(21) Appl. No.: 11/575,974

(22) PCT Filed: Sep. 28, 2005
(86) PCT No.: PCT/IL05/01042

§ 371 Date: Mar. 26, 2007

Related U.S. Application Data
(60) Provisional application No. 60/613,587, filed on Sep. 28, 2004.

(51) Int. Cl. H04M 3/42

(52) U.S. Cl. 379/201.12

(57) ABSTRACT

A digital telephony system which provides telephone services to a plurality of subscribers. The system includes a private branch exchange (PBX) which provides multiple analog telephone lines and includes an interface to a data link. The multi-user system which provides telephone services to subscribers not associated with the PBX, is connected to the PBX by the analog telephone lines. A subscriber accesses the multi-user system by initiating a connection to the multi-user system such as a telephone connection or a message over a cellular network. The multi-user system receives information regarding the telephone connection over the data link thereby generating a call event; and triggers an action based on the information received by synchronizing one of the analog lines to the call event. Preferably the action includes intercepting, or call-back actions, which provide the services to the external subscribers using functionality available in the PBX.

### FIELD AND BACKGROUND OF THE INVENTION

The present invention relates to telephone systems and methods of providing telephone based services integrated with Private Branch Exchange (PBX) systems. Specifically, the present invention provides telephone services using implementations of callback, call-through and follow-me, enabling on-line monitoring, billing and recording of phone calls to subscribers not affiliated with the PBX.

Due to the onset over the past decade of a world-wide global village, and the explosive expansion of the cellular networks, the percentage of the total budget of communications expenses within organizations has increased significantly. The increase in communications expenses requires organizations to manage and control these expenses on the one hand, and lower the per-minute cost on the other hand, thus reducing the total communications expenses. Communications expenses typically include two major segments, fixed-line expenses and cellular phone expenses. In order to control the expenses in the fixed-line segment, organizations are using various software tools such as Call Account systems, and Least Cost Routing (LCR) software. In addition, hardware solutions, such as VoIP Gateways, Cellular Adaptors, dedicated lease lines, IP-PBX, etc., are being used to reduce the costs of the calls and data transfer. The solutions used to manage and control the fixed-line expenses are not applicable to the cellular phone expenses since the cellular networks are independent and are not connected to the organizations' PBX. Furthermore, there are no equivalent systems that enable organizations to manage and control the use of cellular phones. Organizations are therefore suffering from two major problems: Lack of control over the usage of cellular phones within the organization, and high per-minute cellular phone costs in local and international calls.

Current solutions for management and control of cellular usage are limited to off-line analysis of cellular bills or to setting a monthly fixed cellular phone calls budget for each employee. Both methods are not ideal since the analysis is performed after the expense has been incurred and the analysis is time consuming for both the management and employees. On the per-minute cost-saving front, there are several solutions such as callback services and calling cards that are being offered by service bureaus and cellular operators, however these solutions are not user-friendly, not comprehensive, and are still relatively expensive.

In some market segments the on-line monitoring, billing and recording of phone calls are required. Existing solutions for monitoring and recording phone calls force organization employees to use only fixed line infrastructure connected with the PBX of the organization and doesn't support the use of mobile phones.

Recording is popular in finance industry (e.g. investment banking, retail banking and stock exchange market) where all incoming and outgoing customers' calls are recorded. Mobile calls (e.g. cellular) are not typically included in recording systems today of financial institutions because the cellular telephone network is external to the PBX of the financial institution.

Legal advisors and accountant firms usually bill clients for telephone call consultancies. Existing billing systems can only charge calls made through the office PBX and do not support cellular or other external calls, e.g. voice over Internet Protocol (VoIP).

There is thus a need for, and it would be highly advantageous to have a telephony system which provides a comprehensive solution to include management of external telephone calls including, billing and recording of external (e.g. cellular telephone calls.

Integration of telecommunications equipment with data processing equipment provides powerful tools that coordinate advanced features of digital telephony with computer processing power. For example, callback and call-through systems providing advanced call control and data processing capabilities are available for multiple subscribers based on Interactive Voice Response (IVR) systems that are integrated into PBX systems through an ISDN line or X.25 (T1/E1) line.

Reference is now made to FIG. 1 illustrating a prior art callback and call-through system 10 for a multi-user environment. System 10 performs telecommunications functions such as conference calls, which include establishing circuit connections between a user or subscriber 113 and a destination 115 either through PBX 105 over line 119 or directly through PSTN 103. System 10 is based on IVR server 101 integrated with PBX system 105 through an ISDN line or X.25 (T1/E1) line 107, and connects PBX 105 to telephone network PSTN 103 providing call control and data processing capabilities. System 10 includes a recording system 121, either as a separate system connected to PBX 105 by a communications port 125a or integrated within PBX 105 which records telephone calls of one or more telephone extensions of PBX 105. System 10 further includes a call account or billing system 123 which receives Call Detail Records (CDR) over for instance communications port 125b. CDR includes information, e.g. Account-code or Authorization-code information regarding account information for traffic through PBX 105.

Dialed Number Identification Service (DNIS) is a service sold by telecommunications companies to corporate clients that lets them determine for example which toll-free number was dialed by a customer 113. DNIS is useful in determining how to answer an inbound call.

Automatic number identification is a feature of Inward WATS Service (Wide Area Telephone Service) which permits subscribers to display or capture the telephone numbers of calling parties. ANI service was created by AT&T for internal long-distance billing purposes. Inward WATS Service is purchased by customers so that other telephone users (for example, prospective customers) can call the number toll free.

Prior art IVR servers 101 run applications that detect incoming telephone calls, get pre-connection information from PBX 105 (such as ANI or DNIS information of the incoming call), and pass the information to a computer database application program that employs the information (ANI and DNIS) as an entry point to the database. From the database, IVR server 101 can collect relevant information about caller 113 and then initiate the requested action such as callback or call-through. Prior art IVR servers 101 implementing callback or call-through routing require two voice channels either while connecting subscriber 113 (incoming call) to destination 115 (outgoing call) or while initiating a callback action (1st outgoing call) and then connecting subscriber 113 to destination 115 required (2nd outgoing call). A single E1 line for instance includes 30 lines enabling fifteen simultaneous calls, and if more then fifteen calls are required at the same time an additional E1 card needs to be added.

Interface 107 between the PBX 105 and server 101 establishes a physical and logical connection, which is required for the operation of system 10. IVR server 101 communicates with PBX 105 through a format suitable for transmission over data channel 107, such as the ISDN line or X.25 (T1/E1) line. Through its interface card, PBX system 105 receives commands and performs functions as dictated. PBX 10 then transmits status messages back to IVR server 101.

Although system 10 works to integrate data processing equipment with telecommunications equipment, the integration through the physical and logical connections 107 is often perplexing and difficult to create and maintain. Most PBX 105 architectures are proprietary; therefore physical connection 107 between IVR server 101 and PBX 105 differs depending on the vendor. For example, an Ethernet port, such as the one found on the NEAX 2000 (NEC America, Irving, Tex., US ), will be different from the ISDN BRI link employed by AT&T's Definity system. Computer network managers that have to integrate PBX 105 into the local area network often find the link between the server and PBX 105 to be both cumbersome and unreliable.

Nevertheless the integration of systems 10 for callback or call-through routing into PBX 105 requires massive infrastructure (ISDN or X.25 interfaces) that can grow depending on system traffic statistics.

### REFERENCES

http://en.wikipedia.org/wiki/Dialed_Number_Identification_System

http://en.wikipedia.org/wiki/Automatic_number_identification

### SUMMARY OF THE INVENTION

The terms “traditional PBX” and “circuit switched” PBX are used herein interchangeably. The term “IP PBX” is an example of a “packet switched PBX” which provides telephone services using an Internet protocol. The terms “line” and “extension” as in “analog line and “analog extension” are used herein interchangeably. The term “external network” refers to a communications network connected to the PBX so a service supported by the PBX to local users of the PBX is unavailable to remote users. Examples of “external networks” are PSTN, cellular networks or a data network (e.g. providing telephone services over Internet). An “external user” is connected to the PBX via an external network. The terms “remote” and “external” as in “remote user” and “external user” are used herein interchangeably. The term “initiate” as in “initiate a connection”, or “initiate a telephone connection” does not necessarily establish a telephone connection but is sufficient to transfer pre-connection information. The “previously” as in “previously” available refers to using functionality which is available or supported, such as by PBX 105 and other prior art systems integrated with PBX 105, prior to implementing an embodiment of the present invention.

According to the present invention there is provided a digital telephony system which provides telephone services to a plurality of subscribers. The system includes a private branch exchange (PBX) which provides multiple analog telephone lines. The multi-user system which provides the telephone services to the subscribers, is connected to the PBX by the analog telephone lines and by a data link. A subscriber accesses the multi-user system by initiating a connection to the multi-user system such as a telephone connection or a message over a cellular network. The multi-user system receives information regarding the connection over the data link thereby generating a call event. An action, including either an intercept or call-back action, is triggered based on the information by synchronizing one of the analog lines to the call event. Preferably, the telephone services include call-back, call-through, follow-me, call account services and recording services. Preferably, the action is performed by using a functionality previously supported by the PBX. Preferably, the subscribers include users of an external telephone network. Preferably, the system further includes a recording system connected to one or more analog lines, and the action includes recording a telephone connection. Preferably, the data link is a data link through a local area network, a serial data link, a data link to a cellular modem, and/or a data link operatively attached to a digital telephone connection. Preferably, the PBX is selected a circuit switched PBX or a packet switched PBX.

According to the present invention there is provided a method which provided telephone services to multiple subscribers. A multi-user system is connected to a private branch exchange (PBX) using analog telephone lines. The multi-user system includes an interface to one or more data links. A subscriber accesses the multi-user system and the multi-user system receives receiving information associated with the subscriber over one of the data links thereby generating a call event. The multi-user system triggers an action based on the information by synchronizing one of the analog lines with the call event. Preferably, the subscriber accesses the multiuser system by initiating a telephone connection by dialing a number such as a personalized direct-inward-dialing number or an access number of an organization, or initiating a message, e.g. SMS directed to the multi-user system. Preferably, the information is pre-connection information such as Dialed Number Identification Service information, Automatic Number Identification information or identification information of a simple message service. Preferably, the accessing is performed by initiating a telephone connection by the subscriber, and the action further includes intercepting the telephone connection by the one analog line. Alternatively, the action includes a call-back call to said subscriber. The action may include registering on an account for billing and the billing is performed using a call account system connected to the PBX. The action may include action include recording by connecting a conference call between the subscriber, a destination user and a recording device attached to the one analog line, by utilizing a conference call function previously available in the PBX. Preferably, the method includes optimizing performance of the multi-user system by transferring an existing connection being handled by the one analog line thereby freeing the one analog line for use by another subscriber, and the transferring is performed by utilizing a call transfer feature of the PBX. Preferably, the step of optimizing performance of the multi-user system by routing an existing connection using Least Cost Routing (LCR) software of said PBX. Preferably, the data links included extensions defined as a hunt group, and the accessing is performed by initiating a connection to one of the extensions. When said one extension is busy, the action is performed using another extension of said hunt group.

### BRIEF DESCRIPTION OF THE DRAWINGS

The invention is herein described, by way of example only, with reference to the accompanying drawings, wherein:

FIG. 1 is a prior art drawing of a conventional telephony systems;

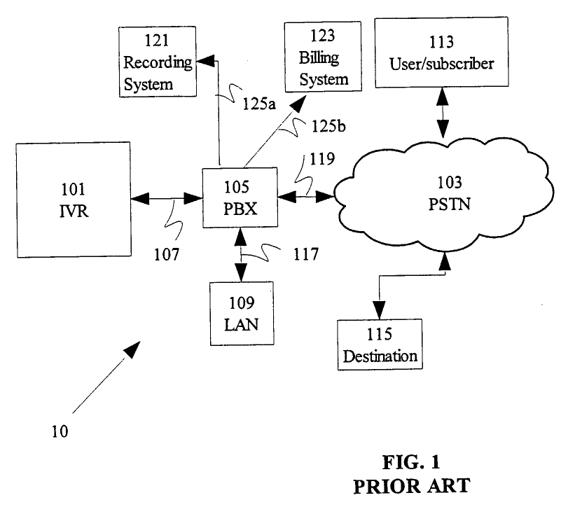

FIG. 2 is a simplified block diagram of a telephony system, according to an embodiment of the present invention;

FIG. 3 is a simplified flow diagram of a method, according to an embodiment of the present invention; and

FIG. 4 is a simplified block diagram of a telephony system, according to another embodiment of the present invention.

### DESCRIPTION OF THE PREFERRED EMBODIMENTS

The present invention is of a system and method for providing telephone services to external subscribers of the system including callback, call-through and follow-me implementations available in prior art PBX systems

The principles and operation of a system and method of providing telephone services, according to the present invention, may be better understood with reference to the drawings and the accompanying description.

It should be noted, that although the discussion herein relates to providing telephony services to cellular telephone users the present invention may, by non-limiting example, alternatively be configured as well using other subscribers using other external networks such as a data network

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, embodiments of the present invention provide seamless integration into a business Private Branch Exchange (PBX) via analog (e.g POTS) extensions and a standard data link either through a communication-port or Local Area Network (LAN) 109 connection, Moreover, embodiments of the present invention require minimal infrastructure and interface easily with a traditional or IP PBX in a simple and innovative way and provide a smart, powerful, easy-to-use and secure routing solutions for remote users 113. The system is capable of using any sophisticated communications systems, previously integrated with PBX 105, including voice over IP (VoIP) gateways, cellular (e.g. GSM Adaptors), X.25 (T1/E1) lines connected to the PSTN 103, billing and call account systems, and recording systems.

According to embodiments of the present invention pre-connection information is typically received from PBX 105 such as the Dialed Number Identification System (DNIS) information, and/or Automatic Number Identification (ANI) information. DNIS and ANI are automatically provided by Public Switched Telephone Network (PSTN) 103 to the organization's PBX 105 with an incoming call. The information is received from PBX 105 to a system of the present invention over a standard data interface preferably provided by the PBX 105 vendor. The information when received generates a call event. A particular intention of embodiments of the present invention is to provide a simple way to synchronize the call event based on the received pre-connection information (e.g. ANI and DNIS) by handling the call event using analog extension integrated with PBX 105. Typically, the analog extension synchronizes with the call event and performs an action, e.g. a call intercept using intercept functionality available in PBX 105. Once synchronized with the call event, only one analog line handles the call event and other analog lines are locked or prevented from handling the call event.

Accordingly, an intention of embodiments of present invention is to provide an innovative multi-user telephony routing system for callback, call-through and follow-me actions, based on existing standard interfaces with PBX 105 such as data links and analog extensions and not using more complicated digital interfaces 107 that exist, such as an ISDN line or X.25 (T1/E1) line.

An additional intention of embodiments of the present invention is to provide a multi-user telephony routing system for callback, call-through and follow-me actions that integrates with both traditional PBX 105 and IP PBX 105.

Another intention of embodiments of the present invention is to utilize prior art recording systems 121 integrated with PBX 105 by providing a simple interface to record telephone calls of remote users 113.

Another intention of embodiments of the present invention is to utilize prior art call account or billing systems 123 integrated with PBX 105 by providing a simple interface with PBX 105 previously integrated with billing system

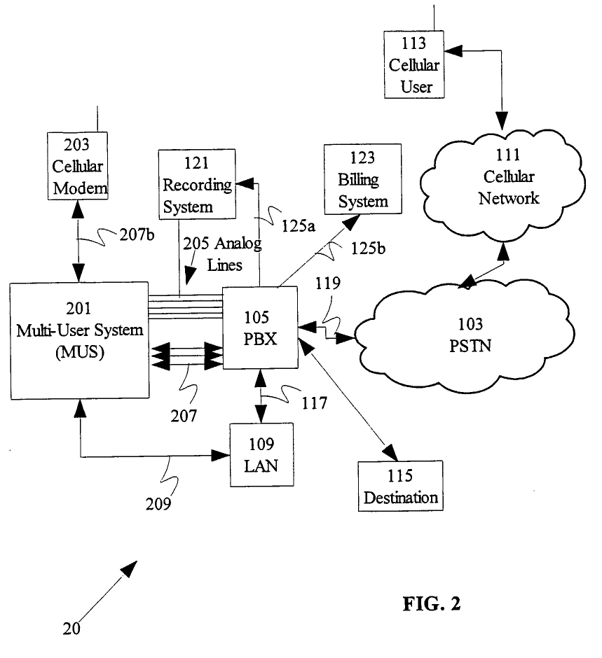

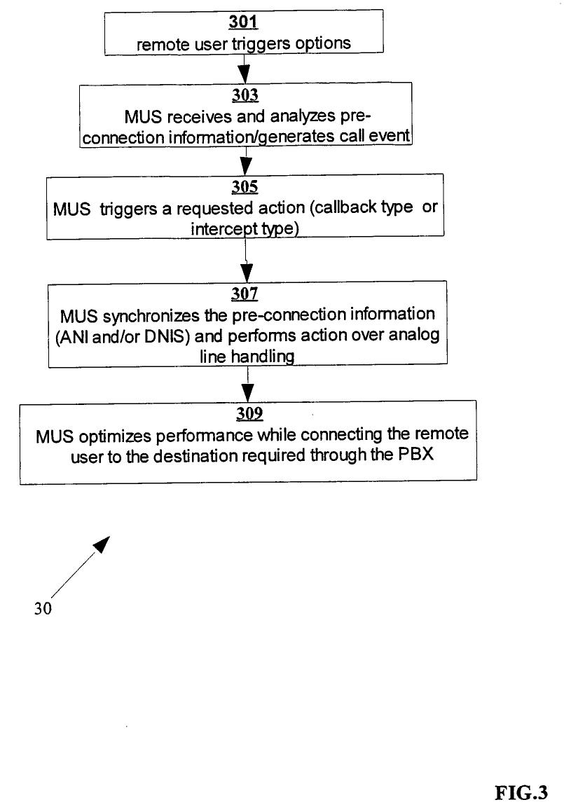

Reference is now made to FIG. 2 and FIG. 3, respectively a system block diagram 20 and a flow diagram 30 of a method, according to embodiments of the present invention. System 20 includes a multiuser system 201 connected to PBX 105 through one or more standard digital interfaces 207 and/or 209 and/or 207b, e.g RS-232, and analog (POTS) telephone lines 205. A remote user 113, e.g. cellular user 113, triggers (step 301) multiuser system 201 (MUS), according to an embodiment of the present invention. The call event triggered by remote user 113 depend on the call action requested (e.g. callback or call-through or follow-me).

According to embodiments of the present invention MUS 201 may be triggered (step 301) by a remote user 113 by calling a Direct-Inward-Dialing (DID) number. For instance a personalized DID number is directed by PBX 105 to MUS 201. Remote user 113 hangs up without generally completing a connection. In this case, system 201 identifies (step 303) the DNIS information supplied by digital PBX 105 with the incoming call via data link interface 207 or alternatively through communication-port 209 from LAN 109.

Typically, in this embodiment in which DNIS information is used, ANI information is not delivered by PSTN 103 to digital PBX 105. The use of DNIS information is typically used when ANI information of the caller is unavailable, and consequently DNIS information provides which user requires a call-back action. In case ANI information is delivered by PSTN 103 to PBX 105, MUS 201 can authenticate user 113 using automatic number identification ANI information.

If both ANI and DNIS information is available to MUS 201, then MUS 20 based on DID information can determine the service required (e.g. follow-me, DID callback or call-through) and based on ANI information MUS 201 can identify remote user 113 for other purposes such as automatic billing. MUS 201 employs the DNIS and/or ANI information as an entry point to a database to inquire which remote user 113 requested action, e.g. follow-me.

According to embodiments of the present invention MUS 201 may be triggered (step 301) by user 113 calling an access number at the organization. In case ANI information is delivered by PSTN 103 to digital PBX 105, MUS 201 can authenticate user 113 by calling user 113 using automatic number identification (ANI). Digital PBX 105 supplies the ANI information to MUS 201 with the incoming call via data link interface 207 or alternatively through communication-port 209 with or without LAN 109. MUS 201 employs the ANI information as an entry point to the database to inquire which user 113 is requesting an action and which action is requested.

According to embodiments of the present invention MUS 201 may be triggered (step 301) by user 113 by sending a message, e.g by an SMS message user 113 to MUS 201, for instance using a cellular modem 203 connected to MUS 201 over data link 207b. In this case MUS 201 identifies the SMS-ID information received by cellular network 111. MUS 201 using standard cellular modem 203 employs the SMS-ID information as an entry point to the database to inquire which user 113 is requesting the “Callback” action.

### Data Link Connection 207 in Traditional PBX 105:

The pre-connection information or the SMS-ID is available through one or more each of standard data link connections 207 or 209 to the PBX, cellular modem 203 through 207b, or through any other equipment which enable getting (step 303) pre-connection information with an incoming call or SMS received.

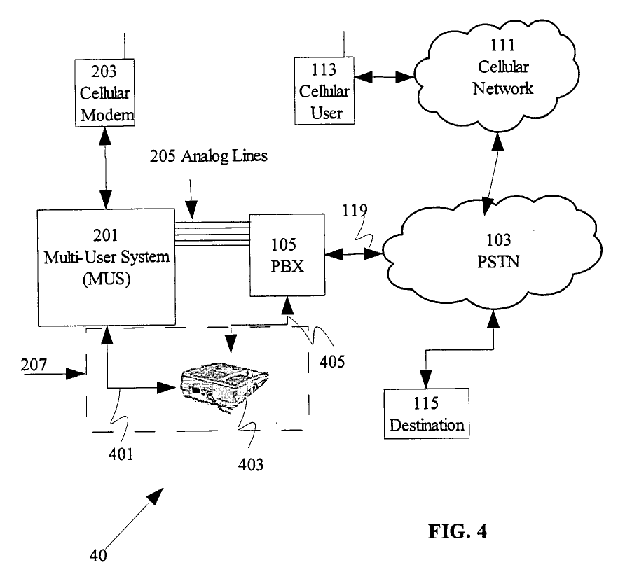

Reference is now also made to FIG. 4 which illustrates an embodiment 40 of the present invention using a traditional digital PBX 105. In embodiments of the present invention, Direct-Inward-Dialing (DID) numbers dedicated to MUS 201 operation (e.g. callback, call-through and/or follow-me) are routed automatically through PBX 105 and through a digital extension 405 to which a digital telephone 403 is connected by an interface 401 completing data link 207. Alternatively, interface 401 connects to a serial interface, e.g. USB, RS232, attached to digital extension 405 which connects to a similar interface on MUS 201.

According to embodiments of the present invention, a hunt group is defined as a feature in PBX 105 on multiple digital extensions 405. Multiple digital extensions 405 are connected each to digital telephone 403 with data link interface 401, which connects to a corresponding communications port, e.g. USB, of system MUS 201. If during the authentication procedure, digital extension 405 is busy, then another digital extension 405 defined in the hunt group will start ringing, and the authentication procedure will be triggered by the other extension 405. In the case of an intercept action, analog line 205 intercepts the incoming call from the other digital extension 405 based on an intercept code received in the action.

In a traditional PBX 105 data link 207 physical interface is generally based on a digital telephone, or a Computer Telephony Interface (CTI) adapter 401 or any other adapter such as RS232-adapter, USB-adapter available to receive (step 303) the pre-connection information data. In some traditional PBXs 105, the PBX vendor also supplies a TAPI (1st party) Service Provider (TSP) software package that enables getting (step 303) the ANI and/or DNIS information of the incoming call using for instance standard Microsoft TAPI software interface. In some traditional PBXs 105 the data link 207 physical interface is based on direct connection to the PBX 105 communications port (which is usually used for call account systems requiring Call Detail Records (CDR) from the PBX 105). In other traditional PBXs 105, data link physical interface 207 is based on a Local Area Network (LAN) connection 117 to PBX 105.

According to some embodiments of the present invention, DID numbers dedicated to MUS 201 operation are routed automatically through PBX 105 to a Ring-Indicator extension. The Ring-Indicator extension is an analog extension 205 connected to MUS 201. The ring indicator extension is used as a trigger (step 301) initiating MUS 201 to request the pre-connection information on the incoming call using either the communication port or LAN connection 207. In some PBXs 105, data link 207 physical interface is based either on direct connection to PBX 105 communication port 125 In this case, MUS 201 usually uses PBX 105 trace command on the Ring-Indicator extension (through the communication port) to get (step 303) the pre-connection information. In case of ‘intercept type’ actions, analog ports 205 are responsible for handling the actions triggered by using the interception functionality of PBX 105. An available analog port 105, responsible for handling the action, intercepts the call from the ‘Ring-Indicator’ extension ringing after the end of authentication, which includes getting (step 303) the pre connection information data from PBX 105 using data link 207 connected. Analog ports 205 are responsible to connect the remote users 113 to the destination 115 requested using the PBX functionality (transfer or conference call features).

### Data Link Connection 207 in IP PBX 105:

MUS 201 can be connected to multiple data links 207,207b, 209 or as many as necessary of each type link to achieve capacity to be able to authenticate multiple users 113 at the same time.

According to some embodiments of the present invention when using an IP PBX 105, IP PBX 105 is connected to PSTN 103 through digital line 119 (e.g ISDN lines or X.25 T1/E1). DID numbers dedicated to MUS 201 operation (e.g. callback call-through and/or follow-me) are routed automatically through the IP PBX 105 to an IP Soft-Phone other IP telephone. A soft phone is basically a virtual IP telephone installed on a standard personal computer of a subscriber and can be used as a dialer allowing the subscriber to get and make calls through the personal computer. The soft phone general user interface (GUI) creates an exact simulation of a standard IP telephone. The soft phone is connected to IP PBX 105 through the PC LAN connection 117. Generally, in IP PBX 105, data link 207 physical interface is based on LAN connection 117 and TAPI Service Provider (TSP) software package, supplied by PBX 105 vendor and is usually used as an interface to a standard soft phone installed on a standard PC. Through the TSP interface MUS 201 can get (step 303) the ANI and/or DNIS information of the incoming call using a standard Microsoft TAPI interface.

In some embodiments of the present invention, data link connection 207b to a cellular modem 203 enables getting (step 303) pre-connection information such as SMS-ID through standard RS232 output and/or USB output. Cellular Modem 203 vendors supply standard API (usually using AT commands) to be able to communicate and negotiate with Cellular Modem 203, and get (step 303) the required information. Cellular modem 203 interface can be easily implemented for ANI or SMS callback actions. When requesting call-through capabilities using cellular modem 203 it is required to use cellular network 111 services to route the incoming call to the PBX 105 extension and still be able to get the ANI information (step 303). Step 303 may be performed using cellular network 111 “Double Ring” service. This service enables defining an alternative land-line telephone number (e.g. DID number), which is going to ring simultaneously with the telephone dialed. The first one which answers, is going to be connected. Alternatively step 303 may be performed using the cellular network 111 “Follow Me” service (on busy state). Follow me service enables defining an alternate landline telephone number to which the incoming call will be forwarded on busy state. By using one of cellular network 111 services described (“Double Ring” or “Follow Me”) the MUS 201 is capable of getting (step 303) the ANI information and still be able to access the incoming call using existing PBX 105 functionality through analog extensions 205.

Reference is now made again to FIG. 2 which illustrates a recording system 121, attached to analog extension 205 and further attached by a data connection 213 to PBX 105, and operative according to an embodiment of the present invention. Prior art recording systems are generally based on the ability to record phone calls by sampling the required extensions on PBX 105 and enable access and retrieval of the required audio recording. MUS 201 recording, which integrates with recording systems 121 already integrated with PBX 105, is based on the ability of existing recording system 121 to record analog ports and the ability of existing recording system 121 to receive Call Detail Records (CDR) from PBX 105 through data connection 125a. In order to enable access and retrieval of a required audio recording of a call routed by MUS 201, MUS 201 can register the call made automatically on the remote user account using Account-code or Authorization-code. Most PBXs 105 support Account-code and/or Authorization-Code when using analog extension 205 by sending a Dual-tone multi-frequency (DTMF) stream (prefix) before the telephone number dialed.

Referring back to FIG. 3, flow diagram 30, MUS 201 triggers (step 305) an event to perform the requested action based on the pre connection information received (step 303) (ANI and/or DNIS information) or the SMS-ID with the incoming call or SMS received. MUS 201 employs the pre-connection information (ANI and/or DNIS information) received (step 303) with the incoming call and/or the SMS-ID as an entry point to the database to be able to decide which action should be taken to handle the current caller 113 (or subscriber 113).

### The Actions:

### Authorized DNIS Callback User Action:

MUS 201 checks in its database if the DNIS information received (step 303) designates a DNIS Callback. If so, MUS 201 checks in its database if the DNIS information received (step 303) requires recording capabilities. If so, MUS 201 checks if the Direct Inward Dialing (DID) number received is attached to any active user. If so, MUS 201 checks if the ANI information received (step 303) is valid for DNIS Callback usage. If so, MUS 201 triggers 305 an Authorized DNIS Callback User action.

### Authorized ANI Call-Through User Section, Call-Back User Action:

MUS 201 checks in its database if the DNIS information received (step 303) is designated for ANI Call-through usage. If so, MUS 201 checks in its database if the DNIS information received (step 303) requires recording capabilities. If so, MUS 201 checks if the ANI information received (step 303) belongs to any active user 113 in the system. If so, MUS 201 checks in its database which type of action is requested: ANI Call-through or ANI Callback. If action type requested is ANI Call-through, the system triggers an Authorized ANI Call-through User action. If action type requested is ANI Callback, MUS 201 triggers an Authorized ANI Callback User action.

### Authorized SMS Callback User Action,

MUS 201 checks if the SMS-ID information received (step 303) belong to any active user 113 in the system. If so, MUS 201 triggers an Authorized SMS Callback User action.

### Follow-Me Action,

MUS 201 authenticates user 113 calling using automatic number identification (ANI) information and identifies the DNIS information supplied by the digital PBX 105. MUS 201 checks in its database if the DNIS information received (step 303) is designated for follow-me usage. Each DID number is related to specific remote telephone number to which the call will be forwarded automatically by MUS 201. If so, MUS 201 checks in its database if the DNIS information received (step 303) requires recording capabilities. If so, MUS 201 checks if the ANI information received (step 303) belongs to any designated account in the system as required for billing purposes. MUS 201 triggers a Follow-me action.

### Un Authorized User Action Description:

In most cases when the pre-connection information (ANI and/or DNIS) received (step 303) with the incoming call and/or the SMS-ID does not match the characteristics required for any active user 113, MUS 201 triggers an Unauthorized User action. In some cases MUS 201 ignores the request and does not trigger any action at all.

Referring back to FIG. 3, MUS 201 system synchronizes (step 307) the pre-connection information (ANI and/or DNIS) with the incoming call or the SMS-ID information by handling over analog line 205. A synchronization module (not shown) in MUS 201 is responsible for synchronizing (step 307) the pre-connection information (ANI and/or DNIS) with the incoming call or the SMS-ID information with an analog port of MUS 201 handling the action. The moment an action is triggered (step 305), one of the available system analog ports 205 acquires the action and locks the action from being handled by another analog port 205. The moment the action is locked, only port 205 that can handle that action is the port 205 acquiring the action. If the action requires recording capabilities, the action will be handled by analog port 205 with recording capability. The recording capability is typically handled by an existing recording system already integrated with PBX 105. Alternatively, a recording system may be integrated with one or more analog ports 205 of MUS 201.

Each action has a type tag defining the way the synchronization 307 is done. Basically, there are two different ways to synchronize 307 the pre-connection information or the SMS-ID over analog port 205 of MUS 201 handling the action.

### Synchronization Action Types Include Intercept Action and Callback Action:

Intercept action—Intercepting the incoming call by analog port 205 handling the action (using functionality of PBX 105).

Callback action—Calling back the authorized user 113 designated by the pre-connection information or the SMS-ID via analog port 205 handling the action.

### Call Interception Procedure:

Remote user 113 triggers (step 301) MUS 201 by calling an access number. MUS 201 analyzes the pre-connection information (ANI and/or DNIS) received (step 303) with the incoming call using standard data link connection 207 or 207b or 209. An action is triggered (step 305) and handled by one of available analog ports 205. In case of intercept type action, analog port 205 handling the action should intercept the incoming call. The fact that analog port 205 is connected to PBX 105 through a simple analog extension enables the port 205 to use existing functionality of PBX 105 in order to intercept the incoming call from the extension ringing. A call interception feature of PBX 105 using analog lines 205 works by picking up analog line 205, changing status of analog line 205 into off-hook position and sending required DTMF stream (call interception feature code). In some PBXs 105 the call interception code is relevant only to the pickup group members defined in PBX 105. This means that only an analog extension 205, which is part of the pickup group, can intercept a call from the other members of the group using the call interception code. In some PBXs 105 the call interception code is configured of a feature code and the extension number (from which the call is being intercepted). Basically, after the call interception is done, analog port 205 carrying the incoming call is synchronized (step 307) with the pre-connection information. This enables analog port 205 to handle the action as required.

### Callback Procedure Description:

Remote user 113 triggers (step 301) MUS 201 by calling a DID number or sending an SMS. MUS 201 receives (step 303) and analyzes the pre-connection information (ANI and/or DNIS) received with the incoming call or the SMS-ID information using standard data link connection. An action is triggered (step 305) and handled by one of the available system analog ports 205. If the action requires recording capabilities, the action will be handled by recorded analog port 205. The recording capability can be handled by the existing recording system already integrated with PBX 105. In case of callback type action the system analog port 205 handling the action should call back the remote user 113 asking for action. The fact that analog port 205 is connected to PBX 105 through a simple analog extension enables the port 205 to use functionality of PBX 105 in order to call back remote user 113 through analog extension 205. MUS 201 using PBX 105 functionality when calling back remote user 113 has the following advantages: PBX 105 typically includes Least Cost Routing (LCR) software which automatically redirects the call back through the cheapest way available (e.g. cellular gateways, VoIP routers etc.). The callback call is registered automatically on the user account for billing purposes using Account-Code or Authorization-Code to billing system 123. PBX 105 can designate the account that should be charged for this call. This advantage enables track of calls made by each user 113 using MUS 201 through the existing call account system 123 already integrated with PBX 105. Basically, when calling back remote user 113 asking for the action, analog port 205 carrying the call is already synchronized (step 307) with the pre-connection information.

### Intercept Type Actions Include:

Authorized ANI Call-through User action, Follow-me action, and Un Authorized User action. Callback type actions include: Authorized DNIS Callback User action, Authorized ANI Callback User action, Authorized SMS Callback User action.

Referring back to FIG. 3, MUS 201 optimizes (step 309) performance while connecting the remote user 113 to a destination 115 required through the PBX 105. After synchronizing (step 307) the pre-connection information or the SMS-ID over the system analog port 205.

In the case ‘callback’ or ‘call through’ action types, an authorized remote user 113 gets an instruction to enter the telephone number requested. User 113 instructs MUS 201 (for example by sending a DTMF stream) to which destination 115 to be connected. MUS 201 connects user 113 to destination 115 requested through the same analog extension 205 using existing functionality of PBX 105.

In the case of ‘follow-me’ action type, MUS 201 forwards user 113 calling automatically to the required subscriber (designated by the DID number called) via PBX 105 through analog extension 205. MUS 201 either hangs up after the action is complete, releasing analog port 205 to be used by another potential user 113 or stays on the line during the whole session due to for instance a requirement of recording system 121.

In the case of ‘unauthorized user’ action type: User 113 is disconnected automatically by MUS 201 by intercepting the call and immediate hanging up.

There are different ways to use functionality of PBX 105 to connect remote user 113 to destination 115 using the same analog extension 205 by: using PBX 105 “Call-Transfer” feature or using PBX 105 “Conference-Call” feature.

One of the most powerful advantages of embodiments of the present invention is the ability to route remote user 113 to destination 115 requested, but still supporting other users 113 requesting for callback, call-through and follow-me actions. By using the “Call-Transfer” feature to route remote user 113 to destination 115 requested, port 205 which handles the action disconnects and is ready for service as soon as the transfer action is done. In this case PBX 105 holds the call using trunk-to-trunk connectivity. Using the “Call-Transfer” feature increases system efficiency, necessary for multi-user environment and automatically minimizes system resources (e.g. number of analog ports 205) required to handle traffic demands. Furthermore, using the “Call-Transfer” feature MUS 201 automatically takes advantage of digital disconnect control mechanism of a digital PBX (comparing to other analog solutions).

The ability to use the PBX conference feature through single analog extension 205 to connect remote user 205 to destination 115 requested is a powerful advantage of embodiments of the present invention. By using the conference feature and not requiring self conference capabilities, MUS 201 automatically decreases the number of resources (ports) required by half, increasing system efficiency.

If the action requires recording, PBX 105 allows recording through single analog extension 205 by using a conference feature, typically available as a feature in PBX 105 to connect remote user 113 to requested destination 115 along with analog port 205 handling the action. Analog port 205 while being recorded is occupied during the entire call and is ready for further services when the current call terminates. In this case PBX 105 is holding the call by creating a three-way conference call which members are handling port 205, remote user 113 and destination 115. In addition the ability to stay on the line during the entire call enables MUS 201 to provide self-call account reporting, prepaid and self-recording capabilities.

Furthermore, by using “Call-Transfer” feature of PBX 105, MUS 201 optimizes performance. MUS 201 using the capabilities of PBX 105 when connecting remote user 113 to destination 115 enables additional advantages including using Least Cost Routing (LCR) software of PBX 105, which automatically redirects the call through the cheapest way available (cellular gateways, VoIP routers etc.), and registering the call automatically on the remote user account for billing purposes. When using the PBX “Call-Transfer” feature to connect user 113 to the requested destination 115, MUS 201 takes advantage of digital disconnect control mechanism of a digital PBX 205 thereby enhancing system performances.

Therefore, the foregoing is considered as illustrative only of the principles of the invention. Further, since numerous modifications and changes will readily occur to those skilled in the art, it is not desired to limit the invention to the exact design and operation shown and described, and accordingly, all suitable modifications and equivalents may be resorted to falling within the scope of the invention.

While the invention has been described with respect to a limited number of embodiments, it will be appreciated that many variations, modifications and other applications of the invention may be made.

What is claimed is:

1. A digital telephony system which provides telephone services to a plurality of subscribers, the system comprising:
(a) a private branch exchange (PBX) which provides a plurality of analog telephone extensions;
(b) a multi-user system which provides the telephone services to the subscribers, wherein said multi-user system is operatively connected to said PBX by said analog telephone extensions; wherein said multi-user system includes an interface to at least one data link;
wherein at least one of said subscribers accesses said multi-user system by initiating a connection to said multi-user system;
wherein said multi-user system receives information associated with said connection over said at least one data link thereby generating a call event; and
wherein said multi user system triggers an action based on said information by synchronizing one of the analog lines with said call event.

2. The system, according to claim 1, wherein at least one service of the telephone services is selected from the group of consisting of call-back, call-through, follow-me, call account services and recording services.

3. The system, according to claim 1, wherein said action is performed using a functionality supported by said PBX.

4. The system, according to claim 1, wherein the subscribers include at least one user of an external telephone network.

5. The system, according to claim 1, further comprising:
(c) a recording system operatively connected to at least one of said analog lines wherein said action includes recording a telephone connection.

6. The system, according to claim 1, wherein said at least one data link is selected from the group consisting of: a data link through a local area network, a serial data link, a data link to a cellular modem, and a data link operatively attached to a digital telephone connection.

7. The system, according to claim 1, wherein said PBX is selected from the group consisting of: a circuit switched PBX and a packet switched PBX.

8. A method which provides telephone services to a plurality of subscribers, the method comprising the steps of:
(a) providing a plurality of analog telephone extensions connecting to a private branch exchange (PBX);
(b) operatively connecting a multi-user system to said PBX using said plurality of analog telephone lines; wherein said multi-user system includes an interface to at least one data link;
(c) accessing said multi-user system by a subscriber of said telephone services;
(d) receiving information associated with said subscriber over said at least one data link thereby generating a call event; and
(e) triggering an action based on said information by synchronizing one of the analog lines with said call event.

9. The method according to claim 8, wherein said accessing is performed by initiating a telephone connection by said subscriber of the telephone services by dialing a number selected from the group consisting of a personalized direct- inward-dialing number and an access number of an organization.

10. The method according to claim 8, wherein said accessing is performed by initiating a telephone connection by said subscriber of the telephone services by dialing a number associated with at least one of the telephone services.

11. The method according to claim 8, wherein said accessing is performed by initiating a message directed to said multi-user system.

12. The method according to claim 8, wherein said information is selected from the group consisting of pre-connection information, information of Dialed Number Identification Service, information of Automatic Number Identification and identification information of a simple message service.

13. The method according to claim 8, wherein said accessing is performed by initiating a telephone connection by said subscriber, wherein said action further includes intercepting the telephone connection by said one analog line.

14. The method according to claim 8, wherein said action includes a call-back call to said subscriber.

15. The method according to claim 8, wherein said action includes registering on an account for billing.

16. The method according to claim 15, wherein said billing is performed using a call account system operatively connected to said PBX.

17. The method according to claim 8, wherein said action includes recording by connecting a conference call between said subscriber, a destination user and a recording device attached to said one analog line, by utilizing a conference call function previously available in said PBX.

18. The method according to claim 8, further comprising the step of optimizing performance of said multi-user system by transferring an existing connection being handled by said one analog line thereby freeing said one analog line for use by another subscriber, wherein said transferring is performed by utilizing a call transfer feature of said PBX.

19. The method according to claim 8, further comprising the step of optimizing performance of said multi-user system by routing an existing connection using Least Cost Routing (LCR) software of said PBX.

20. The method according to claim 8, wherein said at least one data link is a plurality of extensions defined as a hunt group, wherein said accessing is performed by initiating a connection to one of said extensions, wherein upon said one extension is busy, said action is performed using another extension of said hunt group.
